(19) United States
(12) Patent Application Publication
(10) Pub. No.: US 2005/0286544 A1
(43) Pub. Date: Dec. 29, 2005

(54) Scalable transmit scheduling architecture

(76) Inventors: Duncan M. Kitchin, Beaverton, OR (US); Krishnan Rajamani, San Diego, CA (US); Jaya L. Jeyaseelan, San Diego, CA (US); Tejaswini, San Diego, CA (US); Peter D. Ekner, Hilleroed (DK)

Correspondence Address: INTEL CORPORATION, P.O. BOX 5326, SANTA CLARA, CA, 95056-5326, US

(21) Appl. No.: 10/877,118

(22) Filed: Jun. 25, 2004

(51) Int. Cl. H04L 12/28; H04L 12/54

(52) U.S. Cl. 370/412; 370/235; 370/428

(57) ABSTRACT

In one embodiment, a method is provided. The method of this embodiment provides selecting one of a plurality of host transmit queues on a host memory by selecting an entry from a queue descriptor list on a network device, the selected entry being associated with one or more packets on the host memory, retrieving at least one of the one or more packets from the host memory, and storing the at least one of the one or more packets in a device transmit queue of the network device.

### FIELD

Embodiments of this invention relate a scalable transmit scheduling architecture.

### BACKGROUND

Host memory accesses in a host system can often impose unwanted latency on a network device in the host system, thereby imposing a performance limitation. For example, to transmit data from a source destination may require many accesses to host memory in order to select one of possibly many transmit queues on the host memory that may be used for transmitting packets. One way to alleviate this latency is to offload at least some of the transmit operations onto the network device.

While the use of a network device to perform some or all of these transmit operations may greatly reduce these latencies, and may therefore be very efficient, the use of a network device may also be very costly because of its memory requirements. For example, in a wireless environment, a network device may need the capacity for a large number of transmit queues for holding data to be transmitted to clients.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a network according to one embodiment.

FIG. 2 illustrates a system according to one embodiment.

FIG. 3 illustrates a scalable transmit scheduling architecture according to one embodiment.

FIG. 4 illustrates a method according to one embodiment.

FIG. 5 illustrates a method according to one embodiment.

FIG. 6 illustrates packet retrieval in a scalable transmit scheduling architecture according to one embodiment.

### DETAILED DESCRIPTION

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

Embodiments of the present invention may be provided, for example, as a computer program product which may include one or more machine-accessible media having machine-executable instructions that, when executed by one or more machines such as a computer, network of computers, or other electronic devices, may result in the one or more machines carrying out operations in accordance with embodiments of the present invention. A machine-accessible medium may include, but is not limited to, floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable media suitable for storing machine-executable instructions.

Moreover, embodiments of the present invention may also be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

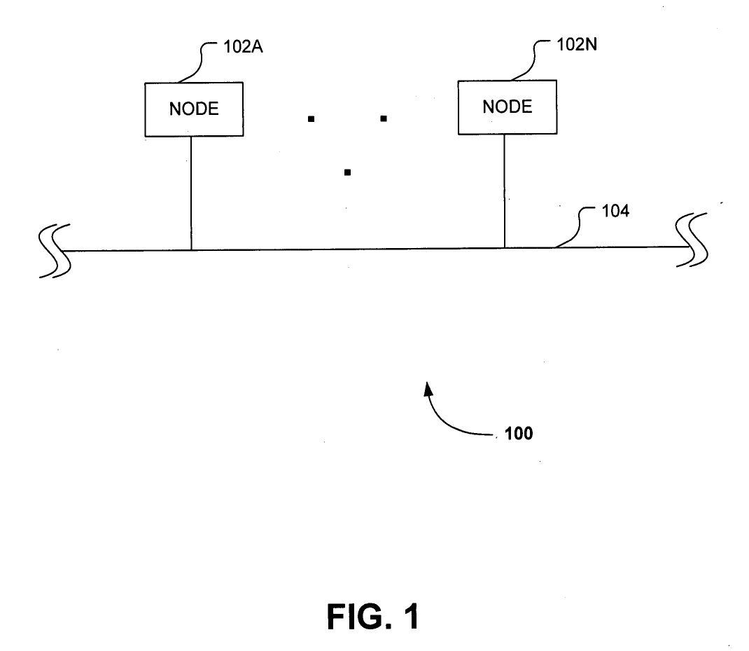

FIG. 1 illustrates a network 100 in which embodiments of the invention may operate. Network 100 may comprise a plurality of nodes 102A, 102N, where each of nodes 102A, . . . 102N may be communicatively coupled together via a communication medium 104. As used herein, components that are “communicatively coupled” means that the components may be capable of communicating with each other via wirelined (e.g., copper wires), or wireless (e.g., radio frequency) means. Nodes 102A . . . 102N may transmit and receive sets of one or more signals via medium 104 that may encode one or more packets.

As used herein, a “packet” a unit of transmission having a sequence of one or more symbols and/or values that may be encoded by one or more signals transmitted from at least one sender to at least one receiver. As used herein, a packet may refer to a protocol packet or a frame. A protocol packet may be formed in higher-level protocols at the source and then fragmented to fit into the data field of one or more frames. A frame may outline the structure for delineating data sent over a communication channel.

As used herein, a “communication medium” means a physical entity through which electromagnetic radiation may be transmitted and/or received. Communication medium 104 may comprise, for example, one or more optical and/or electrical cables, although many alternatives are possible. For example, communication medium 104 may comprise, for example, air and/or vacuum, through which nodes 102A . . . 102N may wirelessly transmit and/or receive sets of one or more signals.

In network 100, one or more of the nodes 102A . . . 102N may comprise one or more intermediate stations, such as, for example, one or more hubs, switches, and/or routers; additionally or alternatively, one or more of the nodes 102A . . . 102N may comprise one or more end stations. Also additionally or alternatively, network 100 may comprise one or more not shown intermediate stations, and medium 104 may communicatively couple together at least some of the nodes 102A . . . 102N and one or more of these intermediate stations. Of course, many alternatives are possible.

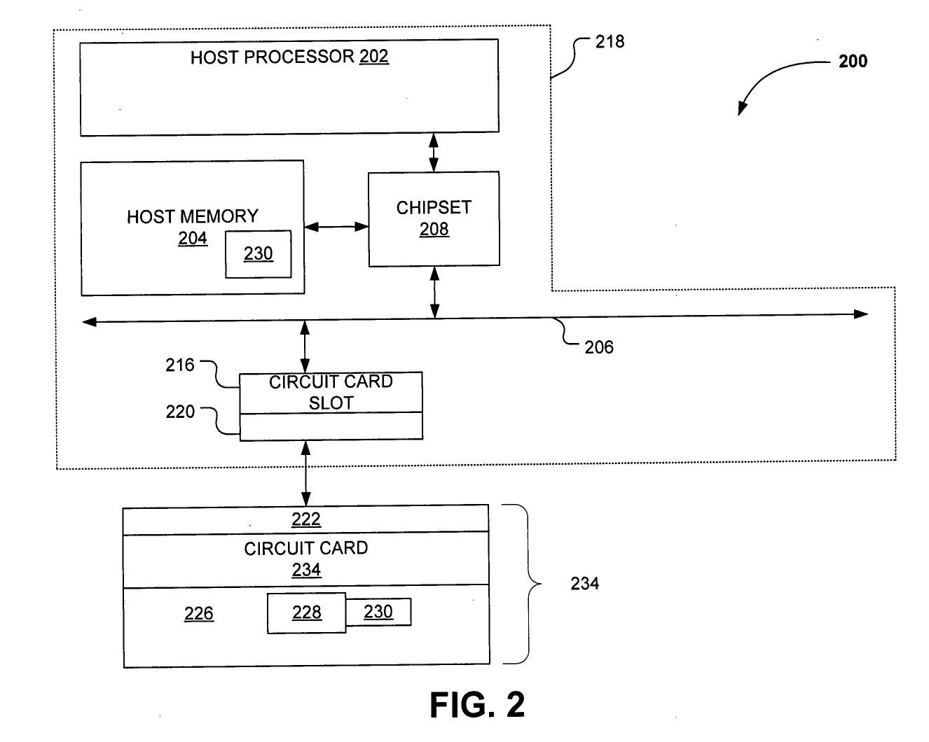

At least one of nodes 102A, . . . , 102N may comprise system 200, as illustrated in FIG. 2. System 200 may comprise host processor 202, bus 206, chipset 208, circuit card slot 216, and connector 220. System 200 may comprise more than one, and/or other types of processors, buses, chipsets, circuit card slots, and connectors; however, those illustrated are described for simplicity of discussion. Host processor 202, bus 206, chipset 208, circuit card slot 216, and connector 220 may be comprised in a single circuit board, such as, for example, a system motherboard 218.

Host processor 202 may comprise, for example, an Intel® Pentium® microprocessor that is commercially available from the Assignee of the subject application. Of course, alternatively, host processor 202 may comprise another type of microprocessor, such as, for example, a microprocessor that is manufactured and/or commercially available from a source other than the Assignee of the subject application, without departing from this embodiment.

Chipset 208 may comprise a host bridge/hub system that may couple host processor 202, and host memory 204 to each other and to bus 206. Chipset 208 may include an I/O bridge/hub system (not shown) that may couple a host bridge/bus system of chipset 208 to bus 206. Alternatively, host processor 202, and/or host memory 204 may be coupled directly to bus 206, rather than via chipset 208. Chipset 208 may comprise one or more integrated circuit chips, such as those selected from integrated circuit chipsets commercially available from the Assignee of the subject application (e.g., graphics memory and I/O controller hub chipsets), although other one or more integrated circuit chips may also, or alternatively, be used.

Bus 206 may comprise a bus that complies with the Peripheral Component Interconnect (PCI) Local Bus Specification, Revision 2.2, Dec. 18, 1998 available from the PCI Special Interest Group, Portland, Oreg., U.S.A. (hereinafter referred to as a “PCI bus”). Bus 206 may comprise other types and configurations of bus systems. For example, bus 206 may comprise a bus that complies with the Mini PCI Specification Rev. 1.0, also available from the PCI Special Interest Group, Portland, Oreg., U.S.A.

Circuit card slot 216 may comprise a PCI expansion slot that comprises a PCI bus connector 220. PCI bus connector 220 may be electrically and mechanically mated with a PCI bus connector 222 that is comprised in circuit card 224. Circuit card slot 216 and circuit card 224 may be constructed to permit circuit card 224 to be inserted into circuit card slot 216.

When circuit card 224 is inserted into circuit card slot 216, PCI bus connectors 220, 222 may become electrically and mechanically coupled to each other. When PCI bus connectors 220, 222 are so coupled to each other, circuitry 226 in circuit card 224 may become electrically coupled to bus 206. When circuitry 226 is electrically coupled to bus 206, host processor 202 may exchange data and/or commands with circuitry 226, via bus 206 that may permit host processor 202 to control and/or monitor the operation of circuitry 226.

Circuitry 226 may comprise computer-readable memory 228. Memory 228 may comprise read only and/or random access memory that may store program instructions 230. These program instructions 230, when executed, for example, by circuitry 226 may result in, among other things, circuitry 226 executing operations that may result in system 200 carrying out the operations described herein as being carried out by system 200, circuitry 226, and/or network device 234.

Circuitry 226 may comprise one or more circuits to perform one or more operations described herein as being performed by circuitry 226. These operations may be embodied in programs that may perform functions described below by utilizing components of system 100 described above. Circuitry 226 may be hardwired to perform the one or more operations. For example, circuitry 226 may comprise one or more digital circuits, one or more analog circuits, one or more state machines, programmable circuitry, and/or one or more ASIC's (Application-Specific Integrated Circuits). Alternatively, and/or additionally, circuitry 226 may execute machine-executable instructions to perform these operations.

Instead of being comprised in circuit card 224, some or all of circuitry 226 may instead be comprised in host processor 202, or chipset 208, and/or other structures, systems, and/or devices that may be, for example, comprised in motherboard 218, and/or communicatively coupled to bus 206, and may exchange data and/or commands with one or more other components in system 200.

System 200 may comprise one or more memories to store machine-executable instructions 230 capable of being executed, and/or data capable of being accessed, operated upon, and/or manipulated by circuitry, such as circuitry 226. For example, these one or more memories may include host memory 204, and/or memory 228. One or more memories 204 and/or 228 may, for example, comprise read only, mass storage, random access computer-accessible memory, and/or one or more other types of machine-accessible memories. The execution of program instructions 230 and/or the accessing, operation upon, and/or manipulation of this data by circuitry 226 may result in, for example, system 200 and/or circuitry 226 carrying out some or all of the operations described herein.

System 200 may additionally comprise network device 234. In one embodiment, network device 234 may comprise a wireless NIC (network interface card) that may comply with the IEEE (Institute for Electrical and Electronics Engineers) 802.11 standard. The IEEE 802.11 is a wireless standard that defines a communication protocol between communicating nodes and/or stations. The standard is defined in the Institute for Electrical and Electronics Engineers standard 802.11, 1997 edition, available from IEEE Standards, 445 Hoes Lane, P.O. Box 1331, Piscataway, N.J. 08855-1331. Network device 234 may be implemented in circuit card 224 as illustrated in FIG. 2. Alternatively, network device 234 may be built into motherboard 218, for example, without departing from embodiments of the invention.

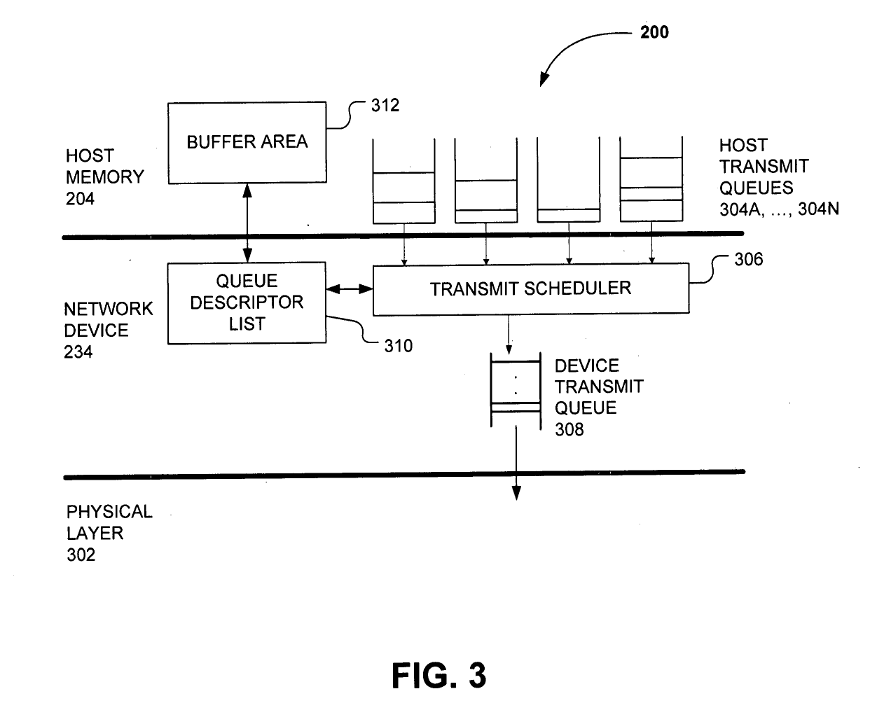

As illustrated in FIG. 3, network device 234 may comprise transmit scheduler 306. Transmit scheduler 306 may perform host transmit queue management, device transmit queue management, packet selection, transmit notification, and retransmissions. In one embodiment, circuitry 226 may be comprised in transmit scheduler 306, and transmit scheduler 306 may perform some or all of the operations described herein as being performed by circuitry 226.

Network device 234 may further comprise one or more device transmit queues 308 (only one shown). As used herein, “device transmit queue” refers to a queue from which physical layer may consume one or more packets stored therein. In one embodiment, device transmit queue 308 may be a FIFO (first in first out) queue. That is, a packet that is moved into the device transmit queue 308 first is moved out of the device transmit queue 308 first. Also, the size of device transmit queue 308 may be based, at least in part, on the latency of the means by which packets can be transferred to the device transmit queue 308 from host memory 204. For example, such means may include the host interface and the transmit scheduler design. In an alternative embodiment, there may be a plurality of device transmit queues 308. In such embodiment, the device transmit queue 308 from which packets are transferred to the physical layer may be selected by any one of a number of well-known algorithms.

Also as illustrated in FIG. 3, host memory 204 may comprise a number of host transmit queues 304A, . . . , 304N, where the number may be a number greater than or equal to 0. Each host transmit queue 304A, . . . , 304N may be associated with a number of packets. That is, each host transmit queue 304A, . . . , 304N may be associated with one or more packets, or it may be associated with no packets. A host transmit queue 304A, . . . , 304N that is associated with a number of packets means that the host transmit queue 304A, . . . , 304N may comprise a corresponding number of mappings to addresses of packets that are available for transmission, such as over network 100.

In one embodiment, packets may be mapped to host transmit queues 304A, . . . , 304N in accordance with a mapping algorithm by host processor 202. A “mapping algorithm” refers to one or more programs and/or procedures that may be used to determine a host transmit queue in which a packet may be placed. The selected queue according to a mapping algorithm may be based on a priority or a client destination, for example.

In one embodiment, each host transmit queue 304A, . . . , 304N may be stored as an entry in queue descriptor list 310. Queue descriptor list 310 may reference one or more packets stored in buffer area 312 of host memory 204, thereby reducing memory requirements on network device 234. Queue descriptor list 310 may further enable efficient access to packets stored in buffer area 312. In one embodiment, queue descriptor list 310 may be stored in host memory 204, and cached on network device 234 using a base address of the queue descriptor list that may be stored in a BAR (Base Address Register).

Queue descriptor list 310 may be scalable, enabling the addition and deletion of entries (i.e., host transmit queues 304A, . . . , 304N) on an as-desired basis. For example, system 200 operate in AP (access point) mode, where system 200 may act as an interface between a wireless network and a wired network, or some other mode in which network device 234 may communicate with one or more other network devices 234, host transmit queues 304A, . . . , 304N may be scalable according to the number of clients. In other words, each client may be associated with one or more host transmit queues 304A, . . . , 304N. Each of the one or more host transmit queues 304A, . . . , 304N associated with a client may be associated with a different priority. As another example, system 200 may operate in client mode, where system 200 may receive services in a network, such as network 100, and host transmit queues 304A, . . . , 304N may be scalable according to the number of supported priorities.

Queue descriptor list 310 may include a list lock that, when enabled, may prevent access to queue descriptor list 310. When list lock is disabled, circuitry 226 may add entries to, and delete entries from, queue descriptor list 310, for example. Likewise, when list lock is enabled, circuitry 226 may be prevented from adding entries to, and deleting entries from, queue descriptor list 310, for example.

Furthermore, each entry in the queue descriptor list 310 may include a queue lock field that prevents access to a corresponding host transmit queue. In one embodiment, this may be used to support power management. For example, in AP mode, where each host transmit queue 304A, . . . , 304N may correspond to a client, host transmit queues 304A, . . . , 304N corresponding to clients in low power mode may be locked to prevent packets from being transmitted to clients that may be in a sleeping state.

Each entry in queue descriptor list 310 may additionally comprise a queue status field that indicates whether the corresponding host transmit queue 304A, . . . 304N is associated with any packets available for transmission. Furthermore, each entry in queue descriptor list 310 may comprise other information, such as, for example, the amount of data in the corresponding host transmit queue 304A, . . . , 304N.

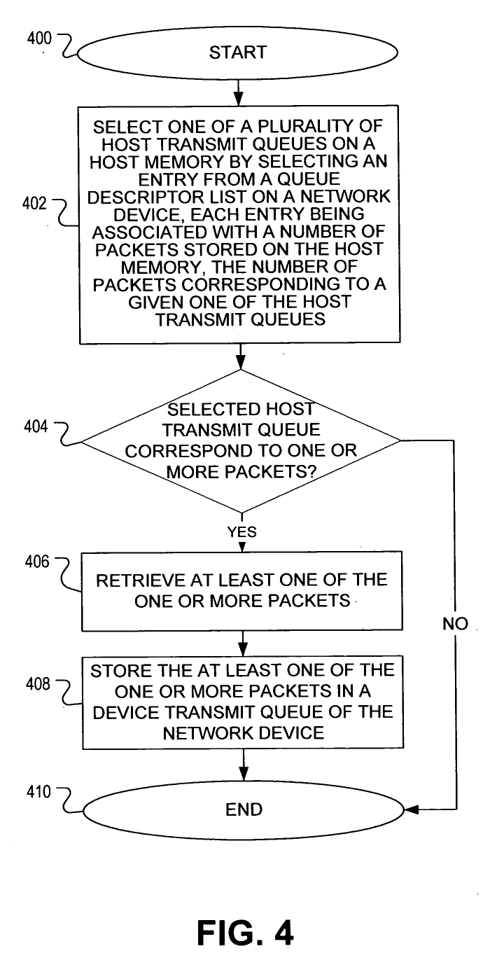

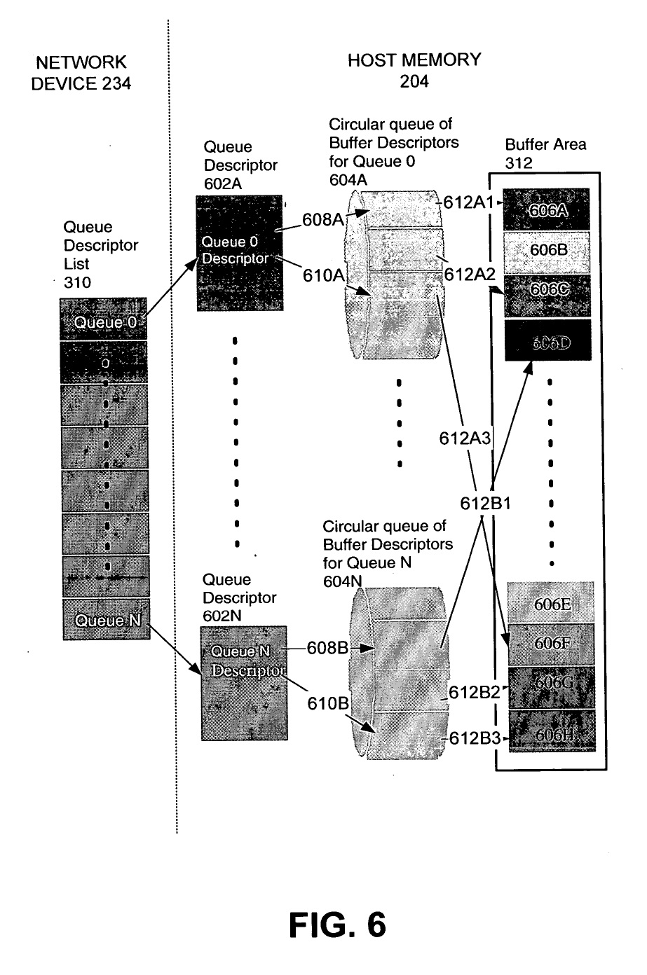

FIG. 4 illustrates a method in accordance with one embodiment of the invention, with additional reference to FIGS. 3 and 6. The method begins at block 400 and continues to block 402 where circuitry 226 may select one of a plurality of host transmit queues 304A, . . . , 304N on a host memory by selecting an entry from a queue descriptor list 310 on a network device 234, each entry being associated with a number of packets stored on the host memory 204, the number of packets corresponding to a given one of the host transmit queues 304A, . . . , 304N.

In one embodiment, circuitry 226 may select a host transmit queue 304A, . . . , 304N in accordance with a selection algorithm on the entries in queue descriptor list 310. As used herein, a “selection algorithm” refers to a procedure in which one host transmit queue of the number of host transmit queues may be selected over another queue of the number of queues. An example of a selection algorithm on entries in the queue descriptor list 310 is to use rotation order, in which a first entry from queue descriptor list 310 is selected over a second entry from queue descriptor list 310 if the first entry is a next queue (as in numerical order) from an entry selected on a previous selection. As another example, in block mechanism, host transmit queue 304A, . . . , 304N may be selected if it comprises a certain amount of data in order to optimize overall system throughput. Of course, other priority algorithms may be used to select host transmit queue 304A, . . . , 304N.

In one embodiment, the method may continue from block 402 to block 404. At block 404, circuitry 226 may determine if the selected host transmit queue 304A, . . . , 304N corresponds to one or more packets. Circuitry 226 may make this determination by checking the queue status field of the corresponding entry in queue descriptor list 310 to determine if the selected host transmit queue 304A, . . . , 304N is associated with one or more packets available for transmission. If at block 404, circuitry 226 determines that the selected host transmit queue 304A, . . . , 304N is associated with one or more packets, then the method may continue to block 406. If at block 404, circuitry 226 determines that the selected host transmit queue 304A, . . . , 304N is not associated with any packets, then the method may continue to block 410.

In an alternative embodiment, the method may continue from block 402 to block 406. In this embodiment, circuitry 226 may eliminate including host transmit queues 304A, . . . , 304N that do not have any packets when selecting a host transmit queue 304A, . . . , 304N.

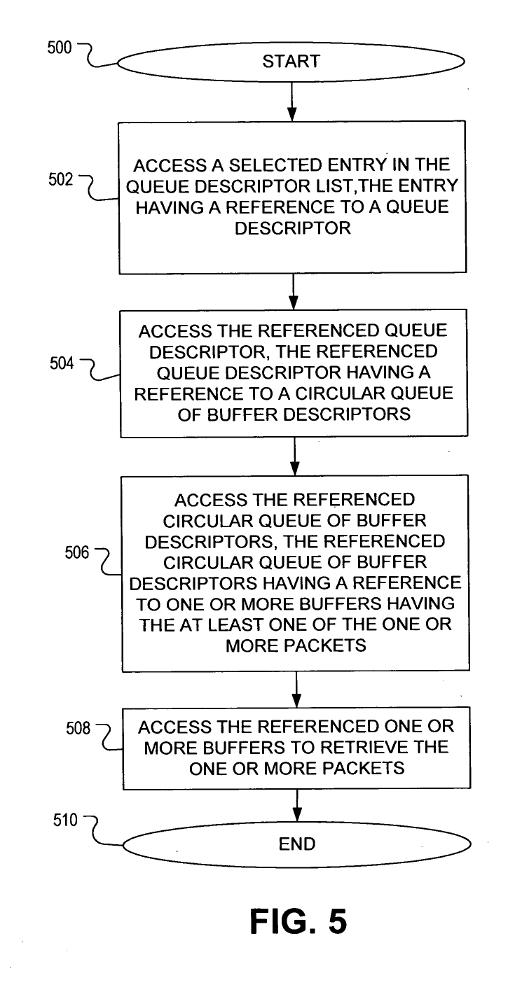

At block 406, circuitry 226 may retrieve at least one of the one or more frames. In one embodiment, circuitry 226 may retrieve at least one of the one or more packets as illustrated in FIG. 5. The method of FIG. 5 begins at block 500 and continues to block 502 where circuitry 226 may access the selected entry Queue 0 . . . Queue N, and the entry Queue 0, . . . , Queue N may have a reference to queue descriptor 602A, . . . , 602N. In one embodiment, each entry in queue descriptor list 310 may comprise a pointer to queue descriptor 602A, . . . , 602N.

At block 504, circuitry 226 may access the referenced queue descriptor 602A, . . . , 602N, the referenced queue descriptor having a reference to circular queue of buffer descriptors 604A, . . . 604N. As used herein, a “queue descriptor” refers to a description of a corresponding host transmit queue 304A, 304N. In one embodiment, each queue descriptor 602A, . . . , 602N may comprise a head pointer 608A, 608B indexing the buffer descriptor in each queue which corresponds to the earliest packet which is valid for transmission; a tail pointer 610A, 610B indexing the buffer descriptor in each queue which corresponds to the latest packet in each queue which is valid for transmission; a queue size indicating the number of entries in the circular queue of buffer descriptors (and therefore, the size of a corresponding host transmit queue), and a start address of the block of memory having the circular buffer descriptor list. In an alternative embodiment, the head and tail pointers may be addresses rather than indices. In this embodiment, the start address may be omitted.

At block 506, circuitry 226 may access the referenced circular queue of buffer descriptors 604A, . . . , 604N, where the referenced circular queue of buffer descriptors 604A, . . . , 604N may have a reference to one or more buffers 606A, 606B, 606C, 606D, 606E, 606F, 606G, 606H having the at least one of the one or more packets. As used herein, a “circular queue of buffer descriptors” refers to a queue of entries in which each entry may comprise a description of a corresponding buffer in buffer area 312 in which a packet may be stored. Each buffer descriptor in circular queue of buffer descriptors 604A, 604N may comprise a pointer 612A1, 612A2, 612A3, 612B1, 612B2, 612B3 to a buffer 606A, 606B, 606C, 606D, 606E, 606F, 606G, 606H in buffer area 606, and may include the size of the buffer 606A, 606B, 606C, 606D, 606E, 606F, 606G, 606H. In an alternative embodiment, the buffer descriptors may contain multiple points, or some other means for referencing multiple buffers, such that the packet may be split across multiple buffers in buffer area 312.

At block 508, network circuitry may access the referenced one or more buffers 606A, 606B, 606C, 606D, 606E, 606F, 606G, 606H to retrieve the one or more packets. In one embodiment, all packets currently in selected host transmit queue 304A, . . . , 304N may be transmitted in a current transmission. In another embodiment, less than all packets currently in the selected host transmit queue 304A, . . . , 304N may be transmitted. For example, a next available packet may be transmitted. On a subsequent transmission, circuitry 226 may transmit a subsequent packet, or it may retransmit the next available packet if the previous transmission was not successful. Once the next available packet is transmitted, circuitry 226 may schedule a subsequent packet to transmit, where the subsequent packet may be from the same host transmit queue 304A, . . . , 304N as the previous one, or it may be different.

The method of FIG. 5 ends at block 510.

Referring back to FIG. 4, at block 408, circuitry 226 may store the at least one of the one or more packets in device transmit queue 308 (FIG. 3) of network device 234. Packets in device transmit queue 308 may be consumed by physical layer 302, and subsequently sent over network 100. Circuitry 226 may receive a transmit status from a transmitted packet, and may use this status to determine a next packet selection.

The method of FIG. 4 ends at block 410.

Conclusion

Therefore, in one embodiment, a method may comprise selecting one of a plurality of host transmit queues on a host memory by selecting an entry from a queue descriptor list on a network device, the selected entry being associated with one or more packets on the host memory, retrieving at least one of the one or more packets from the host memory, and storing the at least one of the one or more packets in a device transmit queue of the network device.

Embodiments of the invention reduce memory requirements on a network device, and therefore the cost of a network device, by enabling a transmit scheduling architecture in which packets for transmission are stored in host memory. Furthermore, the use of a queue descriptor list in which entries corresponding to host transmit queues may be added and deleted enable a scalable transmit scheduling architecture. By storing sufficient information on the queue descriptor list on the network device to enable the network device to perform a queue selection algorithm without referencing any information stored in the host memory, optimum performance may be achieved even in the presence of significant latency in accessing host memory data structures.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

1. A method comprising:
selecting one of a plurality of host transmit queues on a host memory by selecting an entry from a queue descriptor list on a network device, each entry being associated with a number of packets stored on the host memory, the number of packets corresponding to a given one of the host transmit queues; and
if the selected host transmit queue corresponds to one or more packets:
retrieving at least one of the one or more packets from the host memory; and
storing the at least one of the one or more packets in a device transmit queue of the network device.

2. The method of claim 1, wherein each host transmit queue is associated with a priority.

3. The method of claim 1, wherein each host transmit queue is associated with a client to which the one or more packets associated with the host transmit queue is transmitted.

4. The method of claim 1, additionally comprising adding one or more entries to the queue descriptor list.

5. The method of claim 4, additionally comprising locking the queue descriptor list.

6. The method of claim 5, wherein said locking the queue descriptor list comprises setting a list lock field of the queue descriptor list.

7. The method of claim 1, additionally comprising locking one or more of the number of host transmit queues.

8. The method of claim 7, wherein said locking any given one of the one or more of the number of host transmit queues comprises setting a queue lock field of an entry in the queue descriptor list, wherein the entry corresponds to the given host transmit queue.

9. The method of claim 1, wherein said selecting one of the plurality of host transmit queues comprises selecting the host transmit queue using a selection algorithm on entries in the queue descriptor list.

10. The method of claim 1, wherein said retrieving at least one of the one or more packets comprises:
accessing the selected entry in the queue descriptor list, the entry having a reference to a queue descriptor;
accessing the referenced queue descriptor, the referenced queue descriptor having a reference to a circular queue of buffer descriptors;
accessing the referenced circular queue of buffer descriptors, the referenced circular queue of buffer descriptors having a reference to one or more buffer areas having the at least one of the one or more packets; and
accessing the referenced one or more buffer areas to retrieve the at least one of the one or more packets.

11. An apparatus comprising:
circuitry capable of:
selecting one of a plurality of host transmit queues on a host memory by selecting an entry from a queue descriptor list on a network device, each entry being associated with a number of packets stored on the host memory, the number of packets corresponding to a given one of the host transmit queues; and
if the selected host transmit queue corresponds to one or more packets:
retrieving at least one of the one or more packets from the host memory; and
storing the at least one of the one or more packets in a device transmit queue of the network device.

12. The apparatus of claim 11, wherein each host transmit queue is associated with a client to which the one or more packets associated with the host transmit queue is transmitted.

13. The apparatus of claim 11, said circuitry additionally capable of adding one or more entries to the queue descriptor list.

14. The apparatus of claim 11, said circuitry additionally capable of locking one or more of the number of host transmit queues.

15. The apparatus of claim 11, wherein said circuitry capable of retrieving at least one of the one or more packets comprises:
accessing the selected entry in the queue descriptor list, the entry having a reference to a queue descriptor;
accessing the referenced queue descriptor, the referenced queue descriptor having a reference to a circular queue of buffer descriptors;
accessing the referenced circular queue of buffer descriptors, the referenced circular queue of buffer descriptors having a reference to one or more buffer areas having the at least one of the one or more packets; and
accessing the referenced one or more buffer areas to retrieve the at least one of the one or more packets.

16. A system comprising:
a circuit board that includes a circuit card slot; and
a circuit card that is capable of being coupled to the circuit board via the circuit card slot, the circuit card including circuitry that is capable of:
selecting one of a plurality of host transmit queues on a host memory by selecting an entry from a queue descriptor list on a network device, each entry being associated with a number of packets stored on the host memory, the number of packets corresponding to a given one of the host transmit queues; and
if the selected host transmit queue corresponds to one or more packets:
retrieving at least one of the one or more packets from the host memory; and
storing the at least one of the one or more packets in a device transmit queue of the network device.

17. The system of claim 16, wherein each host transmit queue is associated with a priority.

18. The system of claim 16, wherein each host transmit queue is associated with a client to which the one or more packets associated with the host transmit queue is transmitted.

19. The system of claim 16, said circuitry additionally capable of adding one or more entries to the queue descriptor list.

20. The system of claim 16, said circuitry additionally capable of locking one or more of the number of host transmit queues.

21. The system of claim 16, wherein said circuitry is additionally capable of:
accessing the selected entry in the queue descriptor list, the entry having a reference to a queue descriptor;
accessing the referenced queue descriptor, the referenced queue descriptor having a reference to a circular queue of buffer descriptors;
accessing the referenced circular queue of buffer descriptors, the referenced circular queue of buffer descriptors having a reference to one or more buffer areas having the at least one of the one or more packets; and
accessing the referenced one or more buffer areas to retrieve the at least one of the one or more packets.

22. An article comprising a machine-readable medium having machine-accessible instructions, the instructions when executed by a machine, result in the following:
selecting one of a plurality of host transmit queues on a host memory by selecting an entry from a queue descriptor list on a network device, each entry being associated with a number of packets stored on the host memory, the number of packets corresponding to a given one of the host transmit queues; and
if the selected host transmit queue corresponds to one or more packets:
retrieving at least one of the one or more packets from the host memory; and
storing the at least one of the one or more packets in a device transmit queue of the network device.

23. The article of claim 22, wherein each host transmit queue is associated with a client to which the one or more packets associated with the host transmit queue is transmitted.

24. The article of claim 22, the instructions additionally resulting in adding one or more entries to the queue descriptor list.

25. The article of claim 24, the instructions additionally resulting in locking the queue descriptor list.

26. The article of claim 22, the instructions additionally resulting in locking one or more of the number of host transmit queues.

27. The article of claim 22, wherein said instructions resulting in retrieving at least one of the one or more packets comprise instructions resulting in:
accessing the selected entry in the queue descriptor list, the entry having a reference to a queue descriptor;
accessing the referenced queue descriptor, the referenced queue descriptor having a reference to a circular queue of buffer descriptors;
accessing the referenced circular queue of buffer descriptors, the referenced circular queue of buffer descriptors having a reference to one or more buffer areas having the at least one of the one or more packets; and
accessing the referenced one or more buffer areas to retrieve the at least one of the one or more packets.

28. A method comprising:
selecting one of a plurality of host transmit queues on a host memory by selecting an entry from a queue descriptor list on a network device, the selected entry being associated with one or more packets on the host memory; and
retrieving at least one of the one or more packets from the host memory; and
storing the at least one of the one or more packets in a device transmit queue of the network device.

29. The method of claim 28, wherein said retrieving at least one of the one or more packets comprises:
accessing the selected entry in the queue descriptor list, the entry having a reference to a queue descriptor;
accessing the referenced queue descriptor, the referenced queue descriptor having a reference to a circular queue of buffer descriptors;
accessing the referenced circular queue of buffer descriptors, the referenced circular queue of buffer descriptors having a reference to one or more buffer areas having the at least one of the one or more packets; and
accessing the referenced one or more buffer areas to retrieve the at least one of the one or more packets.

30. The method of claim 28, wherein each host transmit queue is associated with a client to which the one or more packets associated with the host transmit queue is transmitted.
